(19) United States
(12) Patent Application Publication
(10) Pub. No.: US 2023/0286512 A1
(43) Pub. Date: Sep. 14, 2023

(54) INFORMATION PROCESSING DEVICE, VEHICLE SYSTEM, AND INFORMATION PROCESSING METHOD

(71) Applicant: TOYOTA JIDOSHA KABUSHIKI KAISHA, Toyota-shi (JP)

(72) Inventors: Yosuke MORIUCHI, Toyota-shi (JP); Ryo YAMADA, Nagakute-shi (JP); Ayana ICHIKAWA, Nagoya-shi (JP); Takashi MIZUNO, Toyota-shi (JP); Kimi SUGAWARA, Tokyo (JP); Shigeki MATSUMOTO, Nagoya-shi (JP)

(21) Appl. No.: 18/061,518

(22) Filed: Dec. 5, 2022

(30) Foreign Application Priority Data
Mar. 9, 2022 (JP) 2022-036637

(51) Int. Cl. B60W 40/08; G06V 20/59; G06V 20/56

(52) U.S. Cl. CPC B60W 40/08; G06V 20/597; G06V 20/56; B60W 2540/22

(57) ABSTRACT

An information processing device estimates an emotion of a driver of a vehicle based on an image acquired by a camera mounted on the vehicle, and specifies a first point that is a point where a predetermined emotion is estimated as the emotion of the driver.

### CROSS-REFERENCE TO RELATED APPLICATION

This application claims priority to Japanese Patent Application No. 2022-036637 filed on Mar. 9, 2022, incorporated herein by reference in its entirety.

### BACKGROUND

### 1. Technical Field

The present disclosure relates to a video sharing service.

### 2. Description of Related Art

A technique for sensing and utilizing an emotion of a driver of a vehicle has been proposed. Related to this, Japanese Unexamined Patent Application Publication No. 2018-106530 (JP 2018-106530 A) discloses a system for estimating an emotion of a driver and generating a route that does not cause an uncomfortable feeling to the driver.

### SUMMARY

An object of the present disclosure is to enhance convenience of a user of a vehicle.

A first aspect of the present disclosure provides an information processing device including a control unit that executes: estimating an emotion of a driver of a vehicle based on an image acquired by a camera mounted on the vehicle; and specifying a first point that is a point where a predetermined emotion is estimated as the emotion of the driver.

Also, a second aspect of the present disclosure is a vehicle system including: an in-vehicle device mounted on a vehicle; and a server device that manages a plurality of the vehicles. The in-vehicle device includes a first control unit that executes estimating an emotion of a driver of the vehicle based on an image acquired by a camera mounted on the vehicle, and sending, to the server device, emotion data that are data in which the estimated emotion is associated with position information. The server device includes a second control unit that generates data obtained by aggregating an emotion of each of a plurality of the drivers for each point or road section based on the emotion data received from a plurality of the in-vehicle devices.

Also, a third aspect of the present disclosure is an information processing method including: a step of estimating an emotion of a driver of a vehicle based on an image acquired by a camera mounted on the vehicle; and a step of specifying a first point that is a point where a predetermined emotion is estimated as the emotion of the driver.

Another aspect of the present disclosure provides a storage medium storing a program that causes a computer to execute the above-described information processing method, and a computer-readable storage medium that non-temporarily stores the program.

According to the present disclosure, convenience for the user of the vehicle can be enhanced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a vehicle system according to a first embodiment;

FIG. 2 is a system configuration diagram of an in-vehicle device 100 according to the first embodiment;

FIG. 3 is an example of emotion data generated by the in-vehicle device 100;

FIG. 4 is a diagram illustrating data sent and received to and from modules of the in-vehicle device 100;

FIG. 5 is a diagram illustrating data sent and received to and from modules of the in-vehicle device 100;

FIG. 6 is an example of an emotion map generated by the in-vehicle device 100;

FIG. 7 is a flowchart of a first process executed by the in-vehicle device 100;

FIG. 8 is a flowchart of a second process executed by the in-vehicle device 100;

FIG. 9 is a diagram illustrating an outline of a vehicle system according to a second embodiment;

FIG. 10 is a system configuration diagram of an in-vehicle device 100 according to the second embodiment;

FIG. 11 is a system configuration diagram of a server device 200 according to the second embodiment;

FIG. 12 is a sequence diagram of data sent and received in the second embodiment;

FIG. 13 is an example of an emotion map generated in the second embodiment;

FIG. 14 is an example of emotion data generated in a third embodiment;

FIG. 15 is an example of emotion data generated in a fourth embodiment; and

FIG. 16 is an example of an emotion map generated in the fourth embodiment.

### DETAILED DESCRIPTION OF EMBODIMENTS

A system for providing driving support based on an image obtained by imaging the face of a driver of a vehicle is known. For example, based on the face image of the driver, it is possible to detect that the driver is drowsy and encourage the driver to take a break. Further, an emotion of the driver can be detected and appropriate information can be provided.

An information processing device according to the present disclosure provides a technique for guiding an appropriate route based on the emotion of the driver.

An information processing device according to one aspect of the present disclosure includes a control unit that executes: estimating an emotion of a driver of a vehicle based on an image acquired by a camera mounted on the vehicle; and specifying a first point that is a point where a predetermined emotion is estimated as the emotion of the driver.

The camera is, for example, an in-vehicle camera installed to face the inside of the vehicle, but is not limited to the in-vehicle camera as long as the camera can capture an image of the face of the driver. For example, a camera of an omnidirectional drive recorder capable of capturing an image in a 360-degree direction can also be used.

The control unit estimates the emotion of the driver based on the image acquired by the in-vehicle camera, and specifies the first point where the predetermined emotion is detected. The predetermined emotion may be any one or more of a plurality of the predetermined emotions. For example, the emotions such as “anger,” “irritation,” “confusion,” and “joy” may be targeted.

An estimated result may be stored in association with the first point. By accumulating such data (referred to as emotion data), it is possible to determine that a specific emotion tends to occur at a specific point (or road section). Based on the emotion data, a point (or road section) where the driver tends to have a specific emotion may be mapped to a road map.

The control unit may send the emotion data to an external device that collects and organizes the emotions. According to this configuration, the emotion data sent from a plurality of the vehicles can be aggregated by the external device. Thus, for example, it is possible to specify a road section where many drivers cannot comfortably pass, and generate a map indicating the road section.

A vehicle system according to one aspect of the present disclosure is a vehicle system including an in-vehicle device mounted on a vehicle and a server device that manages a plurality of the vehicles. The in-vehicle device includes a first control unit that executes: estimating an emotion of a driver of the vehicle based on an image acquired by a camera mounted on the vehicle; and sending, to the server device, emotion data that are data in which the estimated emotion is associated with position information. The server device includes a second control unit that generates data obtained by aggregating an emotion of each of a plurality of the drivers for each point or road section based on the emotion data received from a plurality of the in-vehicle devices.

As described above, the server device may collect and organize the emotions.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

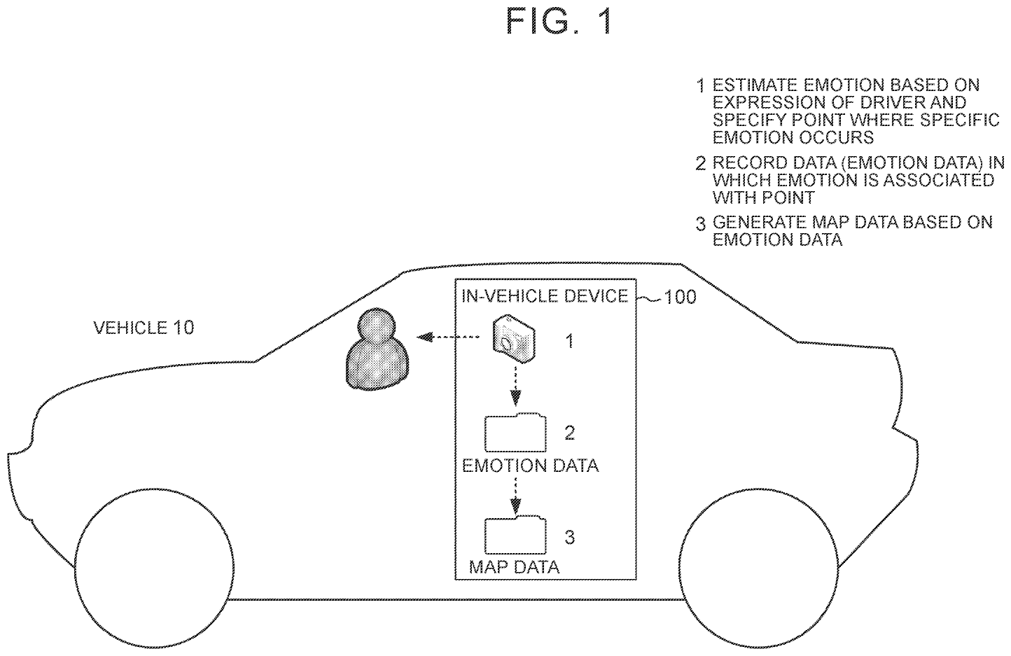

An outline of a vehicle system according to a first embodiment will be described with reference to FIG. 1.

The vehicle system according to the present embodiment includes an in-vehicle device 100 mounted on a vehicle. The in-vehicle device 100 includes a camera capable of imaging the inside of the vehicle, and is configured to be able to estimate the emotion of the driver based on the image acquired by the camera.
When estimating the emotion of the driver periodically while the vehicle is traveling, and detecting a specific emotion, the in-vehicle device 100 stores the result in association with the position information. Further, the in-vehicle device 100 maps the estimated emotion to the road map based on the stored data.

The in-vehicle device 100 will be described in detail.

The in-vehicle device 100 is a computer mounted on the vehicle. The in-vehicle device 100 may be a device (for example, a car navigation device) that provides information to an occupant of the vehicle. The in-vehicle device 100 is also called a car navigation device, an infotainment device, or a head unit. The in-vehicle device 100 can provide navigation and amusement to the occupant of the vehicle.

Further, the in-vehicle device 100 accumulates data while the vehicle 10 is traveling, and provides information to a user (typically driver) of the vehicle based on the accumulated data. In the present embodiment, the in-vehicle device 100 detects the emotion of the driver of the vehicle 10, and generates and outputs the road map to which the detected emotion is mapped for each point or road section.

The in-vehicle device 100 includes a control unit 101, a storage unit 102, a communication unit 103, an input-output unit 104, a camera 105, and a position information acquisition unit 106.

The in-vehicle device 100 can be composed of a general-purpose computer. That is, the in-vehicle device 100 can be configured as a computer having a processor such as a central processing unit (CPU) or a graphics processing unit (GPU), a main storage device such as a random access memory (RAM) or a read-only memory (ROM), an auxiliary storage device such as an erasable programmable read only memory (EPROM), a hard disk drive, and a removable medium. An operating system (OS), various programs, various tables, and the like are stored in the auxiliary storage device. The programs stored in the auxiliary storage device are executed such that various functions can be implemented that match the predetermined purpose, which will be described below. However, some or all of the functions may be implemented by a hardware circuit such as an application specific integrated circuit (ASIC) or a field programmable gate array (FPGA).

The control unit 101 is an arithmetic device that governs the control performed by the in-vehicle device 100. The control unit 101 can be realized by an arithmetic processing device such as the CPU.

The control unit 101 includes three functional modules: an emotion estimation unit 1011, a data generation unit 1012, and a map generation unit 1013. Each functional module may be implemented by execution of a stored program by the CPU.

The emotion estimation unit 1011 acquires the face image of the driver using the camera 105 described below while the vehicle 10 is traveling, and estimates the emotion of the driver based on the face image. The emotion can be estimated using a known technique. For example, the emotion estimation unit 1011 converts the face image into a feature amount, and inputs the obtained feature amount to a machine learning model for estimating the emotion. The machine learning model classifies, for example, the input feature amount into any of a plurality of classes, and outputs the result together with likelihood. Thus, it is possible to obtain the emotion classified into the class and the corresponding likelihood. When there is a class in which the likelihood having a predetermined value or more is obtained, the emotion estimation unit 1011 can determine that the driver has the emotion corresponding to the class. The determination result is sent to the data generation unit 1012.

The data generation unit 1012 generates data (emotion data) in which the estimated emotion and the point are associated based on the result of the estimation performed by the emotion estimation unit 1011.

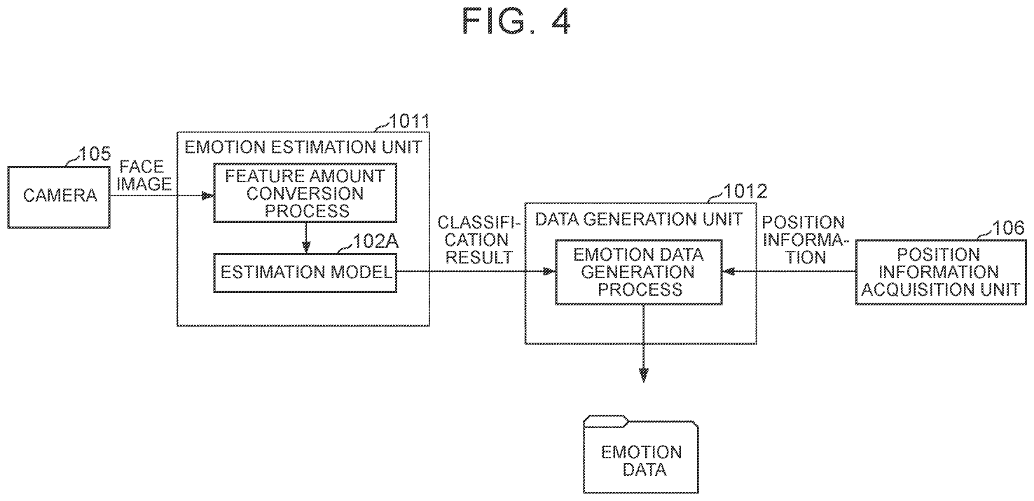

FIG. 3 is an example of the emotion data generated by the data generation unit 1012. In the present embodiment, the emotion data includes date and time information, a trip identifier (trip identification (ID)), position information, and an emotion identifier (emotion ID). The date and time information is date and time when the emotion is estimated. The trip is a unit of travel from when a system power supply of the vehicle is turned on until the system power supply of the vehicle is turned off. The data generation unit 1012 imparts an identifier (trip ID) corresponding to a new trip each time the system power supply of the vehicle is turned on.
The position information is position information (latitude, longitude) of the vehicle 10 acquired by the position information acquisition unit 106 described below.
The emotion identifier is a predefined identifier. For example, when the emotion estimation unit 1011 can identify six kinds of emotions, any of the six kinds of identifiers is stored in the emotion ID.
The data generation unit 1012 generates the emotion data each time the emotion is estimated, and stores the generated emotion data in the storage unit 102 described below.

The map generation unit 1013 maps, to the road map, a point or a road section where a specific emotion occurs based on the stored emotion data, and outputs the result. Hereinafter, the road map to which the emotion is mapped is referred to as an emotion map.

The emotion data used for mapping may be extracted by any criteria. For example, the emotion data generated in a past predetermined period may be extracted and used for mapping. The predetermined period may be designated by the user or determined by the system.
By referring to the emotion map, the user of the vehicle 10 can grasp a point or a road section where the user can travel comfortably or a point or a road section where the user feels stressful while driving.

The storage unit 102 is means for storing information, and is composed of a storage medium such as a RAM, a magnetic disk, or a flash memory.

The storage unit 102 includes a main storage device and an auxiliary storage device. The main storage device is a memory in which a program executed by the control unit 101 and data used by the control program are expanded. The auxiliary storage device is a device in which a program executed by the control unit 101 and data used by the control program are stored. The auxiliary storage device may store a program executed by the control unit 101 such that the program is packaged as applications. Further, an operating system for executing these applications may also be stored. The program stored in the auxiliary storage device is loaded into the main storage device and executed by the control unit 101, so that the process described below will be performed.

The storage unit 102 stores an estimation model 102A, emotion data 102B, and a road data 102C.

The estimation model 102A is a machine learning model for estimating the emotion. The estimation model 102A classifies the feature amount acquired from the image including the human face into a class as an input, and outputs the result. For example, the estimation model 102A classifies the feature amount into any of a plurality of the predetermined emotions. The emotions can be, for example, surprise, excitement, happiness, warning, satisfaction, relaxation, tranquility, drowsiness, boredom, melancholy, pessimism, tension, and dissatisfaction. The estimation model 102A is configured in advance based on image data for learning.

The estimation model 102A may be able to output the likelihood together with the emotion being the classification result.

The emotion data 102B is a collection of a plurality of emotion data generated by the emotion estimation unit 1011.

The road data 102C is road map data serving as a base for generating the emotion map. The road data 102C is, for example, data defining the geographical position and the connection relationship of a road link.

The communication unit 103 includes an antenna for performing wireless communication and a communication module. The antenna is an antenna element that inputs and outputs a wireless signal. In the present embodiment, the antenna is adapted to mobile communication (for example, mobile communication such as the third generation (3G), long term evolution (LTE), and the fifth generation (5G)). The antenna may include a plurality of physical antennas. For example, when mobile communication using radio waves in a high frequency band such as microwaves and millimeter waves is performed, a plurality of antennas may be distributed and disposed to stabilize communication. The communication module is a module for performing mobile communication.

The input-output unit 104 is means for receiving the input operation performed by the user and presenting information to the user. Specifically, the input-output unit 104 is composed of a touch panel and its control means, and a liquid crystal display and its control means. The touch panel and the liquid crystal display are composed of one touch panel display in the present embodiment. The input-output unit 104 may include a unit (amplifier or speaker) for outputting the sound, a unit (microphone) for inputting the sound, etc.

The camera 105 is an optical unit including an image sensor for acquiring an image. In the present embodiment, the camera 105 is installed in a position where the image (face image) including the face of the driver of the vehicle 10 can be acquired. The position information acquisition unit 106 includes a global positioning system (GPS) antenna and a positioning module for positioning the position information. The GPS antenna is an antenna that receives a positioning signal sent from a positioning satellite (also referred to as a global navigation satellite system (GNSS) satellite). The positioning module is a module that calculates the position information based on a signal received by the GPS antenna.

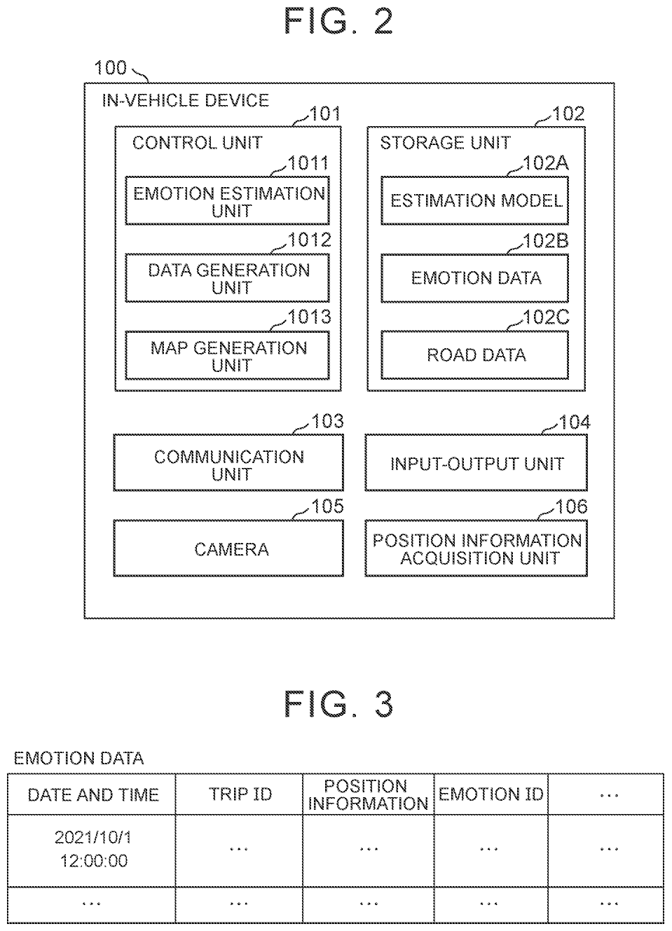

The configuration shown in FIG. 2 is an example, and all or a part of the functions shown in FIG. 2 may be executed using a specially designed circuit. Further, a program may be stored or executed by a combination of the main storage device and the auxiliary storage device other than the functions shown in FIG. 2.

Next, details of a process executed by the in-vehicle device 100 will be described.

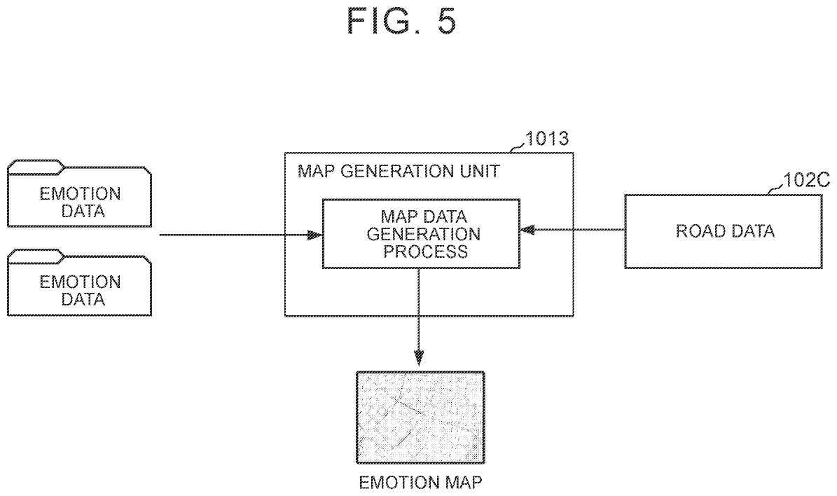

FIGS. 4 and 5 are diagrams illustrating a flow of data between components (modules) of the in-vehicle device 100.
FIG. 4 corresponds to a process for generating the emotion data based on the face image, and FIG. 5 corresponds to a process for generating the emotion map based on the emotion data.

First, the process for generating the emotion data based on the face image (FIG. 4) will be described.

The emotion estimation unit 1011 acquires the face image from the camera 105 while the vehicle 10 is traveling. The face image includes the face of the driver of the vehicle 10. The emotion estimation unit 1011 converts the acquired face image into the feature amount and inputs the feature amount to the estimation model 102A.
As described above, the estimation model 102A is a machine learning model that classifies the feature amount into a class based on the feature amount. As a result, it is possible to obtain the emotion that will be a classification target (for example, “satisfaction,” “tranquility,” “melancholy,” “tension,” “dissatisfaction,” etc.) and the likelihood thereof. The emotion estimation unit 1011 estimates, for example, the emotion with the highest likelihood as the emotion of the driver. The classification result is sent to the data generation unit 1012.

The data generation unit 1012 generates the emotion data shown in FIG. 3 based on the classification result and the position information of the vehicle 10.

The process shown in FIG. 4 is periodically executed while the vehicle 10 is traveling. As a result, a plurality of records of the emotion data is accumulated in the storage unit 102.

Next, with reference to FIG. 5, the process for generating the emotion map based on the emotion data will be described.

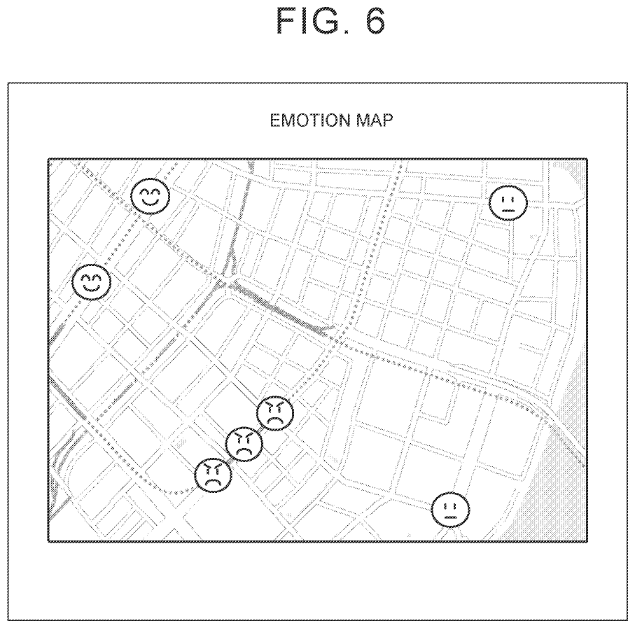

The map generation unit 1013 extracts the emotion data (the records) used for generating the emotion map from the storage unit 102. The emotion data to be extracted may be designated by the user or determined by the system. For example, the emotion data generated in the past predetermined period can be extracted.
The map generation unit 1013 generates a map (emotion map) in which emotions are mapped with respect to points (or road sections) on a road based on the acquired emotion data and the road data 102C stored in the storage unit 102. FIG. 6 is an example of the emotion map generated by the map generation unit 1013. As shown in FIG. 6, the map generation unit 1013 maps a point where any emotion is detected to the road map. The emotion being a target of mapping may be, for example, a negative emotion such as “dissatisfaction” and “melancholy” or a positive emotion such as “happiness” and “satisfaction”. Thus, it is possible to indicate, to the user, a point (or road section) where the user is recommended to pass and a point (or road section) where the user is not recommended to pass. In the example of FIG. 6, icons indicating the emotions are mapped to the road map.
The map generation unit 1013 may, for example, execute mapping when an instruction from the user is given, or may execute mapping when a predetermined condition is satisfied.

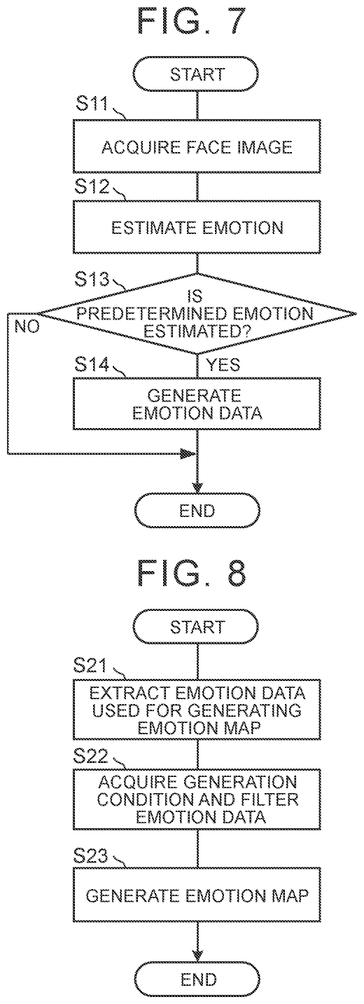

Next, a flowchart of a process executed by the in-vehicle device 100 will be described with reference to FIGS. 7 and 8.

FIG. 7 is a flowchart of the process in which the in-vehicle device 100 generates the emotion data. The process is periodically executed while the vehicle 10 is traveling.
First, in step S11, the emotion estimation unit 1011 acquires the image (face image) of the driver via the camera 105. When the camera 105 also serves as the camera of the drive recorder, the emotion estimation unit 1011 may request the drive recorder to acquire the image.

Next, in step S12, the emotion estimation unit 1011 estimates the emotion of the driver based on the acquired face image. A known method can be employed for estimating the emotion. For example, the emotion estimation unit 1011 converts the acquired face image into the feature amount and inputs the feature amount to the estimation model 102A. Further, the classification result and the likelihood output from the estimation model 102A are acquired, and the emotion with the highest likelihood is determined as the emotion of the driver.

Next, in step S13, it is determined whether the emotion determined by the emotion estimation unit 1011 corresponds to any of a plurality of the preset emotions (for example, “dissatisfaction,” “melancholy,” “happiness,” and “satisfaction”). The determination may be made based on the likelihood output from the estimation model 102A. When the determination result is Yes in step S13, the process proceeds to step S14. When the determination result is No in step S13, the process is terminated. For example, where there is no class having likelihood greater than a predetermined value among the preset classes, the determination result in step S13 is No.

In step S14, the data generation unit 1012 generates the emotion data based on the result of the estimation performed by the emotion estimation unit 1011. As shown in FIG. 3, the emotion data are data in which the identifier of the estimated emotion is associated with the position information. The generated emotion data are stored in the storage unit 102. The emotion data for each trip are accumulated by repeated execution of the process shown in FIG. 7. The data generation unit 1012 may delete emotion data satisfying a predetermined condition (for example, emotion data in which a certain number of days have passed since the emotion data was generated).

Next, a process for generating the emotion map based on the accumulated emotion data will be described. FIG. 8 is a flowchart of the process in which the map generation unit 1013 generates the emotion map. The process shown in FIG. 8 can be executed when a predetermined trigger occurs. The predetermined trigger may be generated, for example, at a timing when a trip of the vehicle 10 ends, or may be generated based on the instruction from the user.

First, in step S21, the emotion data used for generating the emotion map are extracted from the storage unit 102. The target emotion data may be extracted based on the designation from the user or may be extracted according to a predetermined rule. For example, when the process is started at a timing when the trip ends, the emotion data generated in the most recent trip may be targeted. Further, when there is a rule of “using the emotion data corresponding to the trips for the past one month”, the emotion data generated for the past one month may be acquired.

In step S22, a condition (hereinafter referred to as a generation condition) that is a prerequisite for generating the emotion map is acquired, and the emotion data are filtered according to the generation condition. For example, a road condition can change depending on the day and the time zone, such as “weekday mornings,” “weekday evenings,” and “holidays.” Therefore, the emotion data used for generating the emotion map may be filtered according to the day and the time zone. The generation condition may, for example, be designated by the user or automatically determined by the system. For example, when the current date and time are weekday evenings, the emotion map is generated using only the emotion data generated on weekday evenings. Thus, for example, it is possible to visualize “a point where the user should not pass on weekday evenings”.

In step S23, the acquired emotion data are mapped to the road map based on the road data 102C to generate the emotion map. The generated emotion map is output via the input-output unit 104.

As described above, the in-vehicle device 100 according to the first embodiment can estimate the emotion of the driver and map the result to the road map. Thus, it is possible to visualize a point or a road section where a negative emotion occurs, or a point or a road section where a positive emotion occurs. Further, the user of the vehicle can recognize a point (or road section) where the user is recommended to pass and a point (road section) where the user is not recommended to pass by referring to the emotion map.

In the present embodiment, an example in which the emotion map is generated after the vehicle 10 has finished traveling is shown, but the emotion map may be generated in real time (that is, while the vehicle 10 is traveling). In this case, a point where a predetermined emotion is detected may be notified to the driver in real time, and the point may be mapped to the road map (output by a navigation device, for example) in real time.

### Second Embodiment

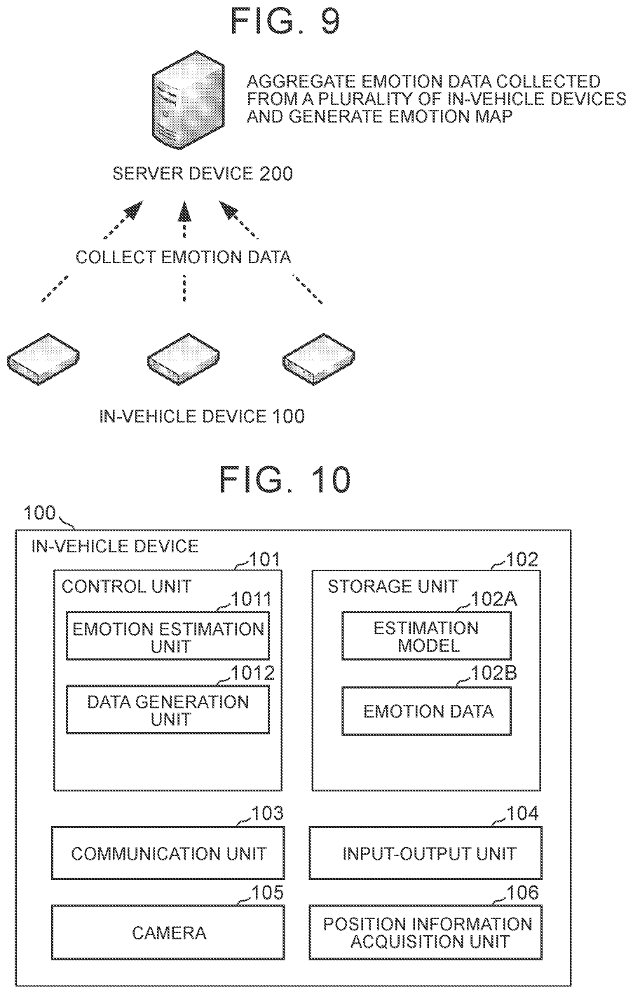

In the first embodiment, the in-vehicle device 100 generates the emotion map. In contrast, in a second embodiment, the in-vehicle devices 100 mounted on a plurality of vehicles 10 send the emotion data to a server device 200, and the server device 200 generates the emotion map based on the emotion data sent from the vehicles 10. FIG. 9 is a schematic diagram illustrating a system configuration in the second embodiment.

FIG. 10 is a system configuration diagram of the in-vehicle device 100 in the second embodiment. As shown in FIG. 10, in the second embodiment, the in-vehicle device 100 does not include the map generation unit 1013 and does not store the road data 102C. The in-vehicle device 100 according to the second embodiment has a function of sending the generated emotion data to the server device 200. The other components are similar to the first embodiment, so detailed description thereof will be omitted.

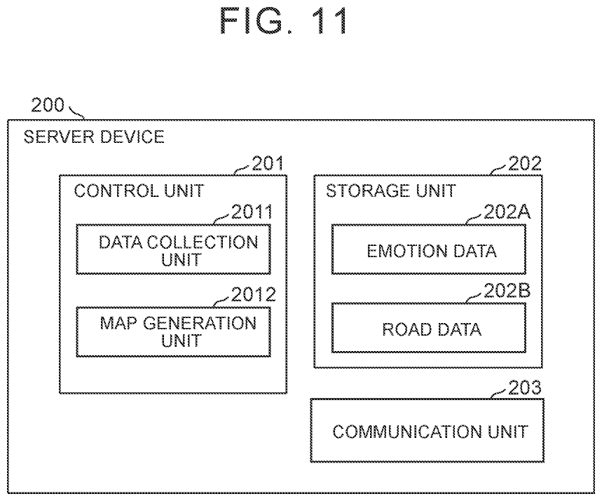

FIG. 11 is a system configuration diagram of the server device 200. The server device 200 receives and accumulates emotion data from a plurality of the in-vehicle devices 100, generates the emotion map based on the accumulated data, and distributes the emotion map to the in-vehicle devices 100.

The server device 200 can be composed of a general-purpose computer. That is, the server device 200 can be configured as a computer having a processor such as a CPU or a GPU, a main storage device such as a RAM or a ROM, an auxiliary storage device such as an EPROM, a hard disk drive, and a removable medium. An operating system (OS), various programs, various tables, and the like are stored in the auxiliary storage device. The programs stored in the auxiliary storage device are loaded into the work area of the main storage device and executed, and through this execution, various components are controlled so that various functions can be implemented that match the predetermined purpose, which will be described below. However, some or all of the functions may be implemented by a hardware circuit such as an ASIC or an FPGA.

The server device 200 includes a control unit 201, a storage unit 202, and a communication unit 203.

The control unit 201 is an arithmetic device that governs the control performed by the server device 200. The control unit 201 can be realized by an arithmetic processing device such as a CPU.
The control unit 201 includes two functional modules: a data collection unit 2011 and a map generation unit 2012. Each functional module may be implemented by execution of a stored program by the CPU.

The data collection unit 2011 receives the emotion data from the in-vehicle devices 100, and stores the emotion data in the storage unit 202 in association with the identifier of the vehicle.

The map generation unit 2012 generates the emotion map based on a plurality of the emotion data stored in the storage unit 202. The map generation unit 2012 may generate the emotion map based on a request sent from the in-vehicle device 100. For example, the map generation unit 2012 generates the emotion map according to the generation condition included in the request, and sends the generated emotion map to the in-vehicle device 100 that has sent the request.

The storage unit 202 includes a main storage device and an auxiliary storage device. The main storage device is a memory in which a program executed by the control unit 201 and data used by the control program are expanded. The auxiliary storage device is a device in which a program executed by the control unit 201 and data used by the control program are stored.

The storage unit 202 stores emotion data 202A and road data 202B.

The emotion data 202A are a collection of emotion data received from the in-vehicle devices 100. An identifier of the vehicle that has generated the emotion data is associated with each of the emotion data.
The road data 202B are road map data serving as a base for generating the emotion map. The road data 202B are the same data as the road data 102C.

The communication unit 203 is a communication interface for connecting the server device 200 to a network. The communication unit 203 includes, for example, a network interface board and a wireless communication interface for wireless communication.

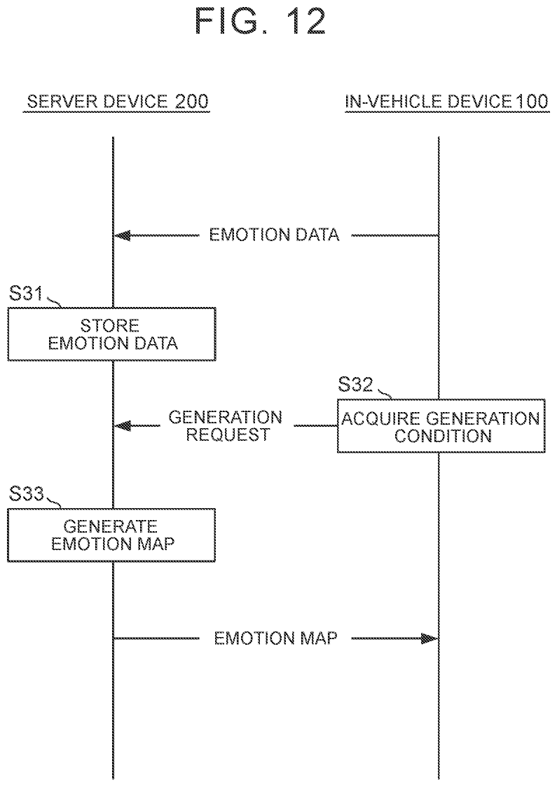

Next, in the second embodiment, a flow of data exchanged between the in-vehicle device 100 and the server device 200 will be described. FIG. 12 is a sequence diagram of the data exchanged between the in-vehicle device 100 and the server device 200.

The in-vehicle device 100 periodically sends the emotion data generated while the vehicle 10 is traveling to the server device 200. The process for the in-vehicle device 100 to generate the emotion data is similar to the process described with reference to FIG. 7.

The server device 200 (data collection unit 2011) stores the received emotion data in the storage unit 202 in association with the identifier of the vehicle (step S31).

In step S32, the in-vehicle device 100 requests the server device 200 to generate the emotion map. Specifically, similar to step S22, a condition (generation condition) as a prerequisite for generating the emotion map is acquired, and a request (generation request) including the generation condition is set to the server device 200. The generation condition may be input by the user via the input-output unit 104.

In step S33, the server device 200 (map generation unit 2012) generates the emotion map based on the received request. Specifically, emotion data that meet the generation condition are extracted from among the emotion data 202A (that is, the emotion data sent from the vehicles), and the extracted emotion data are mapped to the road map recorded in the road data 202B to generate the image.

When a plurality of the emotion data is generated at the same point or road section, the emotion data may be aggregated, and the result may be mapped. For example, a breakdown of the emotions associated with the same point may be generated, and the emotion with the highest ratio may be mapped. Thus, a point or a road section where a plurality of the drivers tends to have specific emotions can be clarified. In addition, the emotions may be broadly classified as “positive,” “neutral,” and “negative,” and the results of the classification may be mapped. Thus, it is possible to clarify a point or a road section where the driver is recommended (or not recommended) to travel.

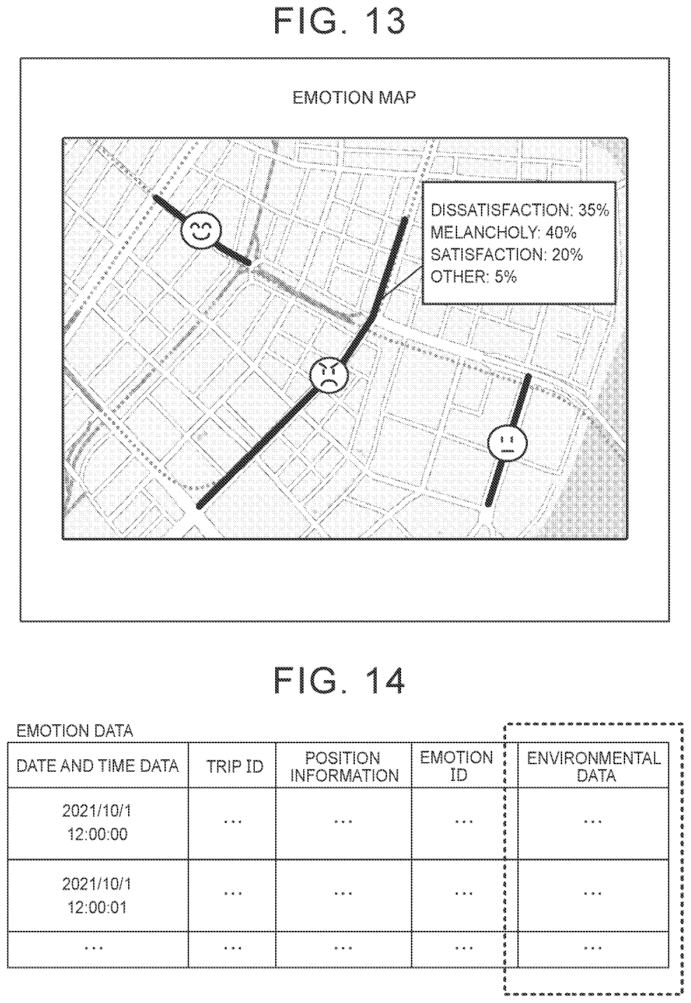

Further, a list representing the breakdown of the emotions may be generated and attached to the emotion map. The list is displayed, for example, by the operation by the user (operation to select a point or a section). FIG. 13 is an example of the emotion map generated by the server device 200. The generated emotion map is sent to the in-vehicle device 100 and output via the input-output unit 104.

As described above, in the second embodiment, the server device 200 collects the emotion data from the in-vehicle devices 100, and generates the emotion map based on the collected emotion data. According to such a configuration, based on the probe data, a point (or road section) where the driver is recommended to pass and a point (road section) where the driver is not recommended to pass can be more appropriately visualized.

In the present embodiment, an example in which the in-vehicle device 100 uploads the emotion data as necessary is shown, but the emotion data may be uploaded at a predetermined timing (for example, when a trip of the vehicle 10 ends).

When a predetermined emotion is detected in the vehicle 10, the driver may be notified that the predetermined emotion is detected, and an inquiry may be made to the driver as to whether the emotion data are sent. For example, when it is detected that the driver has a disgruntled face, the inquiry such as “Are data indicating a negative emotion sent to share the problem that occurs on the road?” may be made.

Further, in the present embodiment, the server device 200 generates the emotion map, but the in-vehicle device 100 may generate the emotion map. In this case, the server device 200 may aggregate the emotions for each point or road section, and send the result (aggregated data) to the in-vehicle device 100. The in-vehicle device 100 may generate the emotion map based on the aggregated data sent from the server device 200.

In the present embodiment, an example in which the server device 200 generates the emotion map based on the request from the in-vehicle device 100 is shown, but the server device 200 may periodically generate and store the emotion map, and send the emotion map to the in-vehicle device 100 when an request is made from the in-vehicle device 100.

### Third Embodiment

In the first embodiment, the emotion data used for generating the emotion map are filtered according to the day and the date and time, but the emotion data may be filtered using elements other than these.

In a third embodiment, the data generation unit 1012 adds data related to a traveling environment of the vehicle 10 to the emotion data, and the map generation unit 1013 performs filtering using the added data. FIG. 14 is an example of the emotion data generated in the third embodiment. As shown in FIG. 14, in this example, environmental data are added to the emotion data. The environmental data are data representing the traveling environment of the vehicle 10. The traveling environment can be, for example, an element affecting the stress of the driver when the vehicle 10 travels, such as weather and traffic volume. The traveling environment may be acquired by a sensor provided in the vehicle 10 or acquired from an external device. For example, when there is a road that is strongly affected by strong winds, information such as “the driver feels uneasy in an environment where strong winds are blowing” is recorded in the emotion data.

In the third embodiment, the emotion data are filtered using the traveling environment in step S22. The traveling environment may be designated by the user or determined by the system. For example, when the current traveling environment is “a strong wind”, the emotion data can be filtered by the weather such as “the strong wind”.

In the third embodiment, as described above, the emotion map corresponding to the specific traveling environment can be generated. For example, when the current traveling environment is “a strong wind”, the emotion generated in the same environment is mapped. Thus, an appropriate emotion map corresponding to the traveling environment can be generated.
The third embodiment may be applied to the second embodiment.

### Fourth Embodiment

A fourth embodiment is an embodiment that presents the image acquired by the in-vehicle camera with the emotion map.

In the fourth embodiment, when the data generation unit 1012 generates the emotion data, an image outside the vehicle 10 (typically an image forward of the vehicle) is acquired via the in-vehicle camera. The in-vehicle camera may also be used as the camera 105. For example, when the camera 105 has an angle of view of 360 degrees, the image outside the vehicle and the face image of the driver can be simultaneously acquired. In this case, the data generation unit 1012 may trim a range corresponding to an area outside the vehicle.

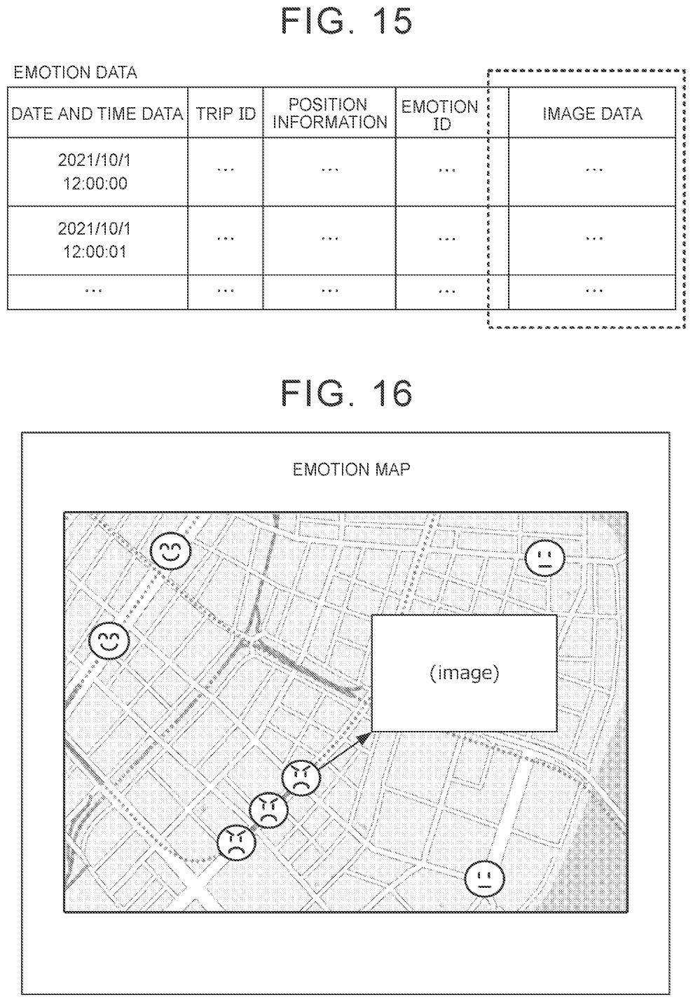

Further, the data generation unit 1012 associates the acquired image with the emotion data. FIG. 15 is an example of the emotion data generated in the fourth embodiment. As shown in FIG. 15, in this example, the image data are added to the emotion data. With reference to the image data, it is possible to know later what causes the change of the emotion of the driver.

Further, in the fourth embodiment, the map generation unit 1013 generates the emotion map in which the image is associated with each point. FIG. 16 is an example of the emotion map generated in the fourth embodiment. As shown in FIG. 16, in the present embodiment, the image is associated with each point where the emotion is mapped, and the image can be confirmed based on the operation by the user.

According to such a configuration, it is possible to confirm later what causes the change of the emotion of the driver.

The fourth embodiment may be applied to the second embodiment.

Further, in this example, the image outside the vehicle is shown as an example, but the image data may include the face image of the driver. Further, in this example, an example in which the still image is used is shown, but the image data may be video data. For example, the still image or the video image including both the image of the area forward of the vehicle and the face image of the driver can be output. Such an image (or video image) may be taken out of the in-vehicle device 100 separately from the emotion data. According to such a configuration, the image (or video image) or the like at the moment when a specific emotion occurs can be provided to the user.

### Modification

The above-described embodiments are merely examples, and the present disclosure may be appropriately modified and implemented without departing from the scope thereof.

For example, the processes and means described in the present disclosure can be freely combined and implemented as long as no technical contradiction occurs.

Further, in the description of the embodiments, an example in which only the emotion map is output is shown, but when there is a point or a road section where the user is recommended to pass, or a point or a road section where the user is not recommended to pass, the reason may be specifically notified to the user.

Further, in the description of the embodiment, an example in which the emotion is estimated from the face image is shown, but the emotion of the driver may be estimated based on other biological information (for example, sound).

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc (CD)-read-only memory (ROM), digital versatile disc (DVD), Blu-ray disc, etc.), a ROM, a RAM, an EPROM, an electrically erasable programmable read only memory (EEPROM), a magnetic card, a flash memory, an optical card, and any type of medium suitable for storing electronic commands.

What is claimed is:

1. An information processing device comprising a control unit that executes:
estimating an emotion of a driver of a vehicle based on an image acquired by a camera mounted on the vehicle; and
specifying a first point that is a point where a predetermined emotion is estimated as the emotion of the driver.

2. The information processing device according to claim 1, wherein the control unit generates emotion data that are data in which the estimated emotion and the first point are associated.

3. The information processing device according to claim 2, wherein the control unit further acquires an image outside the vehicle at the first point, and further associates the image with the emotion data.

4. The information processing device according to claim 3, wherein the camera is a camera that is able to capture an image of scenery forward of the vehicle and an image of a face of the driver simultaneously.

5. The information processing device according to claim 2, wherein the control unit generates a map in which the emotion of the driver is mapped to a point or a road section based on the emotion data.

6. The information processing device according to claim 2, wherein the control unit sends the emotion data to a server device that collects and organizes the emotion data.

7. The information processing device according to claim 6, wherein the control unit receives, from the server device, data obtained by aggregating an emotion of each of a plurality of the drivers for each point or road section.

8. The information processing device according to claim 6, wherein the control unit receives, from the server device, a road map to which a result obtained by aggregating an emotion of each of a plurality of the drivers for each point or road section is mapped.

9. A vehicle system comprising:
an in-vehicle device mounted on a vehicle; and
a server device that manages a plurality of the vehicles, wherein:
the in-vehicle device includes a first control unit that executes
estimating an emotion of a driver of the vehicle based on an image acquired by a camera mounted on the vehicle, and
sending, to the server device, emotion data that are data in which the estimated emotion is associated with position information; and
the server device includes
a second control unit that generates data obtained by aggregating an emotion of each of a plurality of the drivers for each point or road section based on the emotion data received from a plurality of the in-vehicle devices.

10. The vehicle system according to claim 9, wherein the second control unit generates road map data to which a result of the aggregated data is mapped.

11. The vehicle system according to claim 9, wherein the second control unit generates road map data to which a point or a road section where the drivers tend to have predetermined emotions is mapped.

12. The vehicle system according to claim 10, wherein the second control unit periodically generates the road map data based on the emotion data.

13. The vehicle system according to claim 10, wherein:
the second control unit sends the road map data to the in-vehicle device; and
the first control unit outputs the road map data.

14. An information processing method comprising:
a step of estimating an emotion of a driver of a vehicle based on an image acquired by a camera mounted on the vehicle; and
a step of specifying a first point that is a point where a predetermined emotion is estimated as the emotion of the driver.

15. The information processing method according to claim 14, further comprising a step of generating emotion data that are data in which the estimated emotion and the first point are associated.

16. The information processing method according to claim 15, wherein the information processing method further acquires an image outside the vehicle at the first point, and further associates the image with the emotion data.

17. The information processing method according to claim 16, wherein the camera is a camera that is able to capture an image of scenery forward of the vehicle and an image of a face of the driver simultaneously.

18. The information processing method according to claim 15, further comprising a step of generating a map in which the emotion of the driver is mapped to a point or a road section based on the emotion data.

19. The information processing method according to claim 15, further comprising a step of sending the emotion data to a server device that collects and organizes the emotion data.
